(19) United States
(12) Patent Application Publication
(10) Pub. No.: US 2009/0119393 A1
(43) Pub. Date: May 7, 2009

(54) SYSTEM AND ARCHITECTURE FOR SUPPORTING MOBILITY AND MULTIPATH PACKET DELIVERY IN IP NETWORK STACKS

(76) Inventor: JORDI ROS-GIRALT, Aliso Viejo, CA (US)

Correspondence Address: MAIER & MAIER, PLLC, 1000 DUKE STREET, ALEXANDRIA, VA, 22314, US

(21) Appl. No.: 11/935,201

(22) Filed: Nov. 5, 2007

(51) Int. Cl. G06F 15/173

(52) U.S. Cl. 709/223

(57) ABSTRACT

A communication system is provided. The system has at least two nodes communicating with each other with each nodes associated with an operating system, wherein the operating system comprising a costack adapted to generate a unique or a low probability of overlap CID and intercept packets going down or up the main stack at one or more point of interception; and a subspace of a plurality of connections each connection within the subspace having a unique CID in relation to other connections.

### CROSS-REFERENCE TO OTHER APPLICATIONS

The following applications of common assignee are related to the present application, and are herein incorporated by reference in their entireties: U.S. patent application Ser. No. 11/934,858 to ROS-GIRALT, entitled “SYSTEM AND METHOD FOR SUPPORTING MOBILITY AND MULTIPATH PACKET DELIVERY IN IP OMMUNICATIONS AND COMPUTER NETWORKS ACROSS NAT AND FIREWALL BOXES”, having Attorney Docket No. FFTABL-3.

### FIELD OF THE INVENTION

The present invention has one related field of invention: operating systems (OS) and in particular the IP network stack inside the OS.

### BACKGROUND OF THE INVENTION

Despite being a tremendous success, increasingly, the IP protocol suite has been criticized as being too inflexible for the wide-ranging and rapidly evolving application requirements. Two examples of “Internet rigidity” are (1) host mobility and (2) single path packet delivery.

Some legacy constraints make the problem of IP mobility a cumbersome one. For instance, in a typical socket architecture (sockets is an API layer that allows applications to create transport layer connections), connections are by definition bound to a tetrad of source and destination IP addresses and port numbers. Hence if the IP address of a network port is changed while a socket is alive, by definition the connection associated with this socket will break.

The problem of network convergence can be seen as another Internet rigidity. For instance, while in typical computer networks the number of possible paths between a source and a destination is very large, most IP protocols today are defined to use single path connectivity (the two best examples are TCP and UDP protocols). The problem of multipath communication is important because it is intimately related to the concept of network convergence. This concept refers to the capability of a networking system to flexibly, dynamically and transparently integrate networks of different kinds into a single logical pipe with resources equal to the sum of all resources of each of the networks. An example of network convergence could work as follows: a user is in the park and decides to watch the news by using IPTV on her Internet tablet. A single UDP connection is established that starts streaming the news over a certain network, for instance a WIBRO network. But the device detects the existence of a second network, let's say an HSDPA network, and decides to pull resources from both WIBRO and HSDPA networks at the same time to achieve a higher quality stream. The user then decides to go for a cup of coffee. As she enters a coffee shop, her Internet tablet detects a third network, for instance a small WIFI network in the shop. So the device pulls this third resource to achieve and even higher quality of the stream.

Based on this example, an immediate implication of network convergence is that a technology is needed to deliver packets using multiple paths even if the connection between the user and the source of the news is single path in nature (e.g. in the example, a single path UDP connection).

Both mobility and network convergence are complex problems, since the IP network stack implemented in IP boxes was not originally designed for them. The IP protocol is typically implemented in software architectures via an IP network stack residing in the operating system of a computer or, more in general, of an IP-capable device. The suite is divided into protocols organized using a layering approach, that is, a protocol at a higher layer uses a protocol at its immediate lower level to accomplish its aims. A typical software IP stack architecture has 6 layers: application, socket, transport, network, data link and physical layers. It is noted that for the sake of understanding, we include sockets as a separate layer, even though by definition, sockets are an API used by applications to access transport layer protocols. In reality, sockets provide a large number of functionalities besides being a mere API, hence we prefer to refer to it as a layer in itself.

By design, the IP network stack makes several assumptions that limit its potential spectrum of applications. We refer to these assumptions as “IP rigidities” in the stack. One important IP rigidity is referred in the present invention as the tetrad bindings rigidity. In the IP suite, packets are identified to belong to a certain connection based on their source and destination IP addresses and port numbers, referred from this time forth as the packet's tetrad. For instance, in IP unicast, two packets belong to the same connection if and only if they have the same tetrad. This fact is further reflected in commercial IP network stacks, in which packet tetrads are used to find the connection structure associated with packets. In short, the stack assumes that tetrads are invariant throughout the life of a connection. Tetrad bindings is an assumption that constitutes a rigidity in the IP network stack, since for instance this assumption does not hold in the cases of IP mobility or multipath packet delivery (MPD). In mobility, connections between two or more end-points stay alive even if the IP addresses of the end-points change; in MPD, connections between two or more end-points stay alive while having multiple IP sources and/or IP destination addresses and, hence, the rule packets of the same connection have the same tetrad does not hold. Therefore, it is desirous to provide a framework for removing IP rigidities in the IP network stack.

### SUMMARY OF THE INVENTION

It is an object of the present invention to provide a framework for removing IP rigidities in the IP network stack.

Such framework must be constructed in a way that it can seamlessly be integrated with commercial IP stacks, without any disruption.

It is another object of the present invention to provide a method for decoupling the problems of IP node identification and connection identification, also referred herein as the tetrad binding rigidity.

It is still another object of the present invention to provide a method to generate connection IDs that are almost unique within the scope that they are required to be unique. Almost unique is understood as follows: that the probability of not being unique within the required scope is very small or greatly reduced.

A communication system is provided. The system has at least two nodes communicating with each other with each nodes associated with an operating system, wherein the operating system comprising a costack adapted to generate a unique or a low probability of overlap CID and intercept packets going down or up the main stack at one or more point of interception; and a subspace of a plurality of connections each connection within the subspace having a unique CID in relation to other connections.

A method for providing the element of the above system is also provided.

### BRIEF DESCRIPTION OF THE DRAWINGS

The above and other objects and features in accordance with the present invention will become apparent from the following descriptions of preferred embodiments in conjunction with the accompanying drawings, and in which:

FIG. 1 shows an IP system with two costack™ enabled nodes.

FIG. 2 illustrates the concept of overlapping connections.

FIG. 3 shows an example of unfeasible connection IDs.

FIG. 4 shows an example of feasible connection IDs.

### DETAILED DESCRIPTION OF THE PRESENT INVENTION

Certain embodiments as disclosed herein provide for a MAC module that is configured to be deployed in a wireless communication device to facilitate multi-hop wireless network communications over high bandwidth wireless communication channels based on UWB, OFDM, 802.11/a/b/g, among others. In one embodiment, the nodes involved in the multi-hop wireless communications are arranged in a mesh network topology. For example, one method as disclosed herein allows for the MAC module to determine the network topology by parsing beacon signals received from neighbor nodes within communication range and establish high bandwidth communication links with those nodes that are within range to provide a signal quality that supports high bandwidth communication. For applications that require a certain level of quality of service, the methods herein provide for establishing a multi-hop end-to-end route over the mesh network where each link in the route provides the necessary level of signal quality.

After reading this description it will become apparent to one skilled in the art how to implement the invention in various alternative embodiments and alternative applications. To facilitate a direct explanation of the invention, the present description will focus on an embodiment where communication is carried out over a UWB network, although the invention may be applied in alternative networks including 802.11, 802.15, 802.16, worldwide interoperability for microwave access (“WiMAX”) network, wireless fidelity (“WiFi”) network, wireless cellular network (e.g., wireless wide area network (“WAN”), Piconet, ZigBee, IUP multimedia subsystem (“IMS”), unlicensed module access (“UMA”), generic access network (“GAN”), and/or any other wireless communication network topology or protocol. Additionally, the described embodiment will also focus on a single radio embodiment although multi-radio embodiments and other multiple input multiple output (“MIMO”) embodiments are certainly contemplated by the broad scope of the present invention. Therefore, it should be understood that the embodiment described herein is presented by way of example only, and not limitation. As such, this detailed description should not be construed to limit the scope or breadth of the present invention as set forth in the appended claims.

Before addressing details of embodiments described below, some terms are defined or clarified. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

In the following description of the invention, single-medium multiple-access communication systems are assumed to be the intended applicable systems. This assumption is in no way a restriction of the general applicability of the present invention.

The following methods and architectures of the present invention are next presented. They are (1) costack™: insertion method to avoid the disruption of the main stack, (2) method for solving the tetrad binding rigidity, (3) method for generating a unique connection ID.

costack™: insertion method to avoid the disruption of the main IP stack

A key objective of the current invention is to provide a mechanism to remove rigidities in the current IP network stack without disturbing its normal operational flow, i.e. we aim at providing a technology that can seamlessly enhance IP stacks. We refer to this technology with the name of cooperative stack or in short costack™, while we refer to the original stack residing in the operating system (the one enhanced by costack™) as the main stack.

Costack™ works as follows:

Data plane operations: packets going down or up the main stack are intercepted at some point i.e. point of interception (PI) by costack; costack performs some operations onto the packet (e.g. modify header fields, add headers, remove headers, . . . ) and return the packet at the same point where it received it from. Control plane operations: in addition to data plane operations, different costack™ modules in different nodes can communicate to each other in order to control the IP communication system. Such control packets can be encapsulated in standard IP packets although other forms such as proprietary type of packets can also be used.

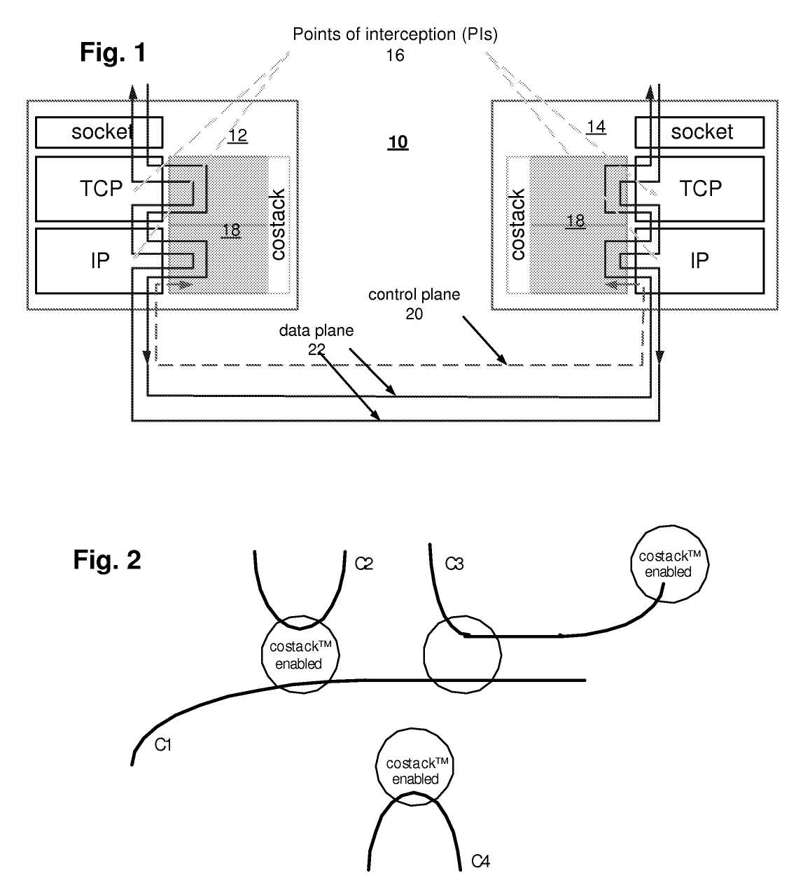

FIG. 1 illustrates an example of a costack™ system 10, with two costack™ enabled nodes, i.e. a first node 12 and a second node 14 communicating with each other. In the present invention, in general, a costack™ system can have an arbitrary number of costack™ enabled nodes communicating with each other. Data plane operations: packets going down or up the main stack are intercepted at some point i.e. point of interception (PI) 16 by costack 18; costack 18 performs some operations onto the packet (e.g. modify header fields, add headers, remove headers, . . . ) and return the packet (not shown) at the same point where it received it from. Control plane 20 operations: in addition to data plane 22 operations, different costack™ modules in different nodes can communicate to each other in order to control the IP communication system. Such control packets can be encapsulated in standard IP packets although other forms such as proprietary type of packets can also be used. In the present invention, the set of operations that costack™ 18 can perform on a packet (data plane operations) have to be unnoticeable by the main stack in the sense that algorithms in the main stack do not need to be changed. In the present invention, the set of operations that costack™ 18 can perform should enable or enhance a set of functionalities that otherwise the main stack would not be able to perform by its own means. Examples of such functionalities are mobility (or enhanced mobility if the stack already provides some sort of IP mobility), multipath packet delivery, enhanced flow control (e.g. rate based flow control), enhanced QoS, etc.

The points of interception PIs 16 where packets are intercepted by costack™ can be multiple and located in multiple locations in the IP stack, depending on the functionality that costack™ 18 is providing. For instance, the bottom part of the IP layer is in general a suitable place to locate costack™ when performing functions of mobility and MPD. An example of costack™ with two points of interception, one at the IP layer and another at the TCP layer, is provided in FIG. 1.

In general, there are two approaches to enhance the main IP stack: (1) to modify the IP stack itself and (2) to insert a mechanism such as costack™ which seamlessly adds functionality and does not require any changes to the main IP stack algorithms. An important advantage of costack™ with respect to the first approach is that IP stacks can be easily enhanced without the need of development support from the organization or enterprise that owns and maintains the main stack. A second advantage is that the first approach can be more disruptive than costack™, since costack™ can be easily disabled by removing the points of interception while changes in the main IP stack cannot be undone.

### Method for Solving the Tetrad Binding Rigidity

In order to solve the tetrad binding rigidity, two key facilities are needed: (1) a connection ID (CID) that identifies packets within the same connection, regardless of the tetrad that this packet carries. Notice that by having a separate ID, the concepts of tetrad and connection can now be cleanly decoupled since no longer are tetrads needed to identify a connection. In this manner, packets with different tetrads can now belong to the same connection, a key property required in order to solve the problems of IP mobility and MPD. The connection ID can be piggybacked on those packets whose tetrads can no longer uniquely identify their connection. (2) a mechanism to swap tetrads on a per packet basis.

In the present invention, costack™ is used as the preferred framework to implement the above facilities. In particular, upon receiving a packet (whether it is going up or down the stack), costack™ can perform the following actions (although by no means the present invention is limited by these actions): Generate a unique CID for this packet, Piggyback the CID onto the packet, and Change the tetrad of a packet based on its CID. Several methods can be used to piggyback the CID onto a packet. Two examples are (1) the use of a new IP option and (2) the use of a new header encapsulated in the packet.

### Method for Generating a Unique Connection ID

The fundamental issue with the tetrad binding rigidity is that while IP addresses were introduced to uniquely identify the location of an IP node, they are also being used in the IP network stack to uniquely identify a connection. But both the problem of locating a node and the problem of identifying a connection are in nature two orthogonal problems. A proper design should not couple them up if rigidities are to be avoided.

The present invention provides a mechanism to decouple IP addresses (or tetrads as a whole) from the notion of connection ID. By its own definition, this mechanism requires a method of generating unique connection IDs. It is observed that while IP addresses have to be universally unique (a well-known problem of IPv4 is that its address space will be too small to accommodate all IP nodes in the future), connection ID's only have to be unique within a certain limited scope. In particular: we say that two connections overlap if both traverse at least one common IP node loaded with a costack™ module; then, in the present invention we will say that a connection ID associated with a certain connection C is feasible if it is different among all the connection IDs associated with connections that overlap with C.

As an example, in FIG. 2 we have that connection C1 overlaps with connection C2 but it does not overlap with either connection C3, or connection C4. Therefore, the connection ID's only have to be unique within the limited scope C1 and C2. Note that although C3 has costack enabled elements therein, but the overlapping elements are not costack enabled. Therefore, C3 is outside the limited scope.

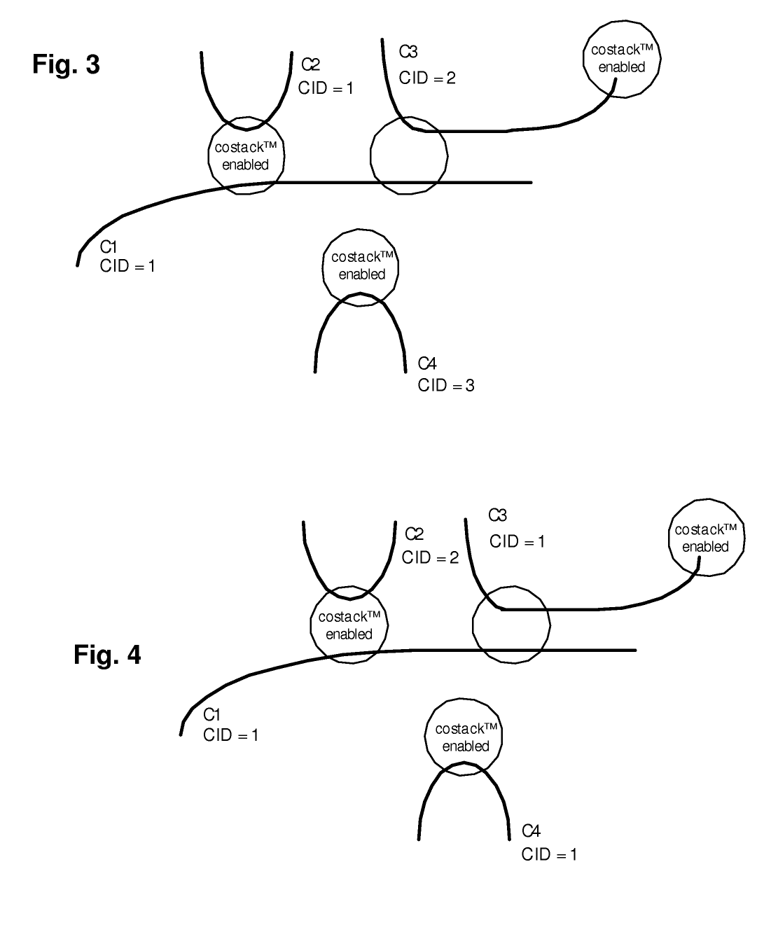

FIG. 3 illustrates an allocation of connection IDs that is not feasible, since C1 and C2 are overlapping connections with the same connection ID. Hence the ID is not unique.

FIG. 4 illustrates an allocation of connection IDs that is feasible, since there is no pair of connections that overlap and share the same connection ID.

From the above definition, it is easy to see that while the space of IP addresses has to be very large to accommodate all possible IP nodes, the space of connection IDs can in general be very small or a limited finite number or function, since in practice connections will not overlap with all the connections active in the Internet but only a few of them.

The problem of generating a feasible connection ID is in general a complicated one, since it must guarantee uniqueness as defined in 0. However, in practice since the minimum space of feasible connection IDs is in general small or limited, the following simple procedure can be used:

upon the need of assigning a new CID to a connection,

use CID=RAND( ),

where RAND( ) is a random generator function of integers.

If the algebraic space of the CID number is large enough, then the probability that two overlapping connections share the same CID will almost be zero. For instance, if CID is a 32 bit integer, then this probability is close to 2⁻³².

To further simplify the operation of assigning a CID to a connection, a proxy function to generate a random number can be built by using the current local clock time. With this approach, if the periodicity of the local clock time is larger than the maximum life of a connection, we can guarantee that a costack™ module will not assign the same CID to two active connections. While this does not guarantee feasibility, the probability of generating an unfeasible CID with this method will still be very small or close to zero for practical operations.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system comprising:
at least two nodes communicating with each other with each nodes associated with an operating system, wherein the operating system comprising a costack adapted to generate a unique or a low probability of overlap CID and intercept packets going down or up the main stack at one or more point of interception; and
a subspace of a plurality of connections each connection within the subspace having a unique CID in relation to other connections.

2. The system of claim 1, wherein the stack is associated with either IP layer, or TCP layer, or both layers.

3. The system of claim 1, wherein the CID is assigned to a connection using a random number generator.

4. The system of claim 1, wherein the CID is assigned to a connection using a proxy function to generate a random number can be built by using the current local clock time.

5. A method comprising:
providing at least two nodes communicating with each other with each nodes associated with an operating system, wherein the operating system comprising a costack adapted to generate a unique or a low probability of overlap CID and intercept packets going down or up the main stack at one or more point of interception; and
providing a subspace of a plurality of connections each connection within the subspace having a unique CID in relation to other connections.

6. The method of claim 5, wherein the stack is associated with either IP layer, or TCP layer, or both layers.

7. The method of claim 5, wherein the CID is assigned to a connection using a random number generator.

8. The method of claim 5, wherein the CID is assigned to a connection using a proxy function to generate a random number can be built by using the current local clock time.
